(19) United States
(12) Patent Application Publication
(10) Pub. No.: US 2016/0286891 A1
(43) Pub. Date: Oct. 6, 2016

(54) HELMET SYSTEM

(71) Applicant: Christopher Stramacchia, Toronto (CA)

(72) Inventor: Christopher Stramacchia, Toronto (CA)

(21) Appl. No.: 15/079,847

(22) Filed: Mar. 24, 2016

Related U.S. Application Data
(60) Provisional application No. 62/142,559, filed on Apr. 3, 2015.

(51) Int. Cl. A42B 3/30; H04L 5/14; A42B 3/04; H04B 7/26

(52) U.S. Cl. CPC A42B 3/30; H04B 7/26; H04L 5/14; A42B 3/0453

(57) ABSTRACT

A helmet comprises a camera, an earphone, a microphone and a communication and control device connected with the camera, the earphone and the microphone. The communication and control device receives video signals from the camera and transmits the video signal out via a first wireless channel, receives a first audio signal from the microphone and transmits the first audio signal out via a second wireless channel, and receives a second audio signal via the second wireless channel and transmit the second audio signal to the earphone.

### PRIORITY CLAIM

This application claims priority to U.S. Provisional Patent Application 62/142,559 entitled “A helmet system” filed Apr. 3, 2015, the contents of which are incorporated herein by reference.

### FIELD OF THE INVENTION

The disclosed embodiments relate generally to a helmet embedded with electronic devices, and more particularly, to a helmet embedded with a video camera, an earphone, a microphone and a wireless communication and control module.

### BACKGROUND OF THE INVENTION

As many electronic devices such as cameras, earphones, microphones, sensors and wireless communication modules become more and more compact and affordable, this kind of development can help realizing many previously undoable applications. For example, a helmet for protecting human head from physical injury, when embedded with electronics devices and batteries, turn to be an amazing data collecting equipment, through which many people can experience what the wearer of the helmet is seeing, hearing even feeling.

Many attempts have been made to provide a helmet with a camera, a microphone/earphone, and a communication module, but either those devices are not integrated into the helmet well, or the communication distance is too short, which prevents the helmet's functions to be taken full advantage of. Or the communication function is not good enough, for example, only a halfduplex or even a simplex audio communication is allowed.

Accordingly, there is a need for an electronic devices equipped helmet with wireless communication capability to enable relative long distance data transmission for video signal, full duplex audio, and other sensor data as well.

### SUMMARY OF THE INVENTION

The above deficiencies and other problems associated with helmet are reduced or eliminated by the disclosed multifunction device. In an aspect of the invention, a helmet comprises a camera, an earphone, a microphone and a communication and control device connected with the camera, the earphone and the microphone. The communication and control device receives video signals from the camera and transmits the video signal out via a first wireless channel, receives a first audio signal from the microphone and transmits the first audio signal out via a second wireless channel, and receives a second audio signal via the second wireless channel and transmit the second audio signal to the earphone.

In another aspect of the invention, the first wireless channel and the second wireless channel is a same wireless channel. In another aspect of the invention, the same wireless channel is any one of WiFi, bluetooth, cellular network, zigbee, cordless phone channel. In another aspect of the invention, the first wireless channel is one of WiFi, bluetooth, cellular network, zigbee, cordless phone channel, and the second wireless channel is the other one of WiFi, bluetooth, cellular network,zigbee, cordless phone channel. In another aspect of the invention, the communication and control device receives and transmits the first audio signal and the second audio signal in a way to enable full duplex audio communication. In another aspect of the invention, the helmet further comprises an impact sensor configured to detect mechanical impact force received by the helmet and connected to the communication and control device. In another aspect of the invention, the communication and control device receives impact detection result from the impact sensor then transmits out the impact detection result via any one of the first wireless channel and the second wireless channel. In another aspect of the invention, the communication and control device receives the impact detection result from the impact sensor, and the communication and control device instructs the earphone to send out audio alarm if the impact detection result reaches a threshold. In another aspect of the invention, the helmet further comprises an alarm means connected with the communication and control device. The communication and control device instructs the alarm means to send out alarm by visible light signal if the impact detection result reaches a threshold. In another aspect of the invention, the impact senor comprises one or more of accelerometer, piezo electric sensor and microelectromechanical system.

In another aspect of the invention, the helmet further comprises a power connection means via which a power source separated from the helmet can be connected to the communication and control device. In another aspect of the invention, the helmet further comprises a speed meter configured to measure speed of the helmet and send the speed measurement result to the communication and control device. The communication and control device transmits out the speed measurement result via any one of the first wireless channel and the second wireless channel.

### BRIEF DESCRIPTION OF THE DRAWINGS

The invention may be more completely understood in consideration of the following detailed description of various embodiments of the invention in connection with the accompanying drawings, in which:

FIG. 1 is a diagram illustrating a helmet in accordance with some embodiments.

FIG. 2 is a block diagram illustrating different parts in the helmet in accordance with some embodiments.

FIG. 3 is a block diagram illustrating different parts in the helmet in accordance with some embodiments.

FIG. 4 is a block diagram illustrating different parts in the helmet in accordance with some embodiments.

FIG. 5 is a block diagram illustrating different parts in the helmet in accordance with some embodiments.

FIG. 6 is a block diagram illustrating different parts in the helmet in accordance with some embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENT

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first gesture could be termed a second gesture, and, similarly, a second gesture could be termed a first gesture, without departing from the scope of the present invention.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Embodiments of a helmet with cameras, earphone, microphone, communications and control device, and sensors are described. In some embodiments, the helmet is a helmet for sport activities such as hokey, football, baseball, motorcycle, equestrian, roller blade, ski, snow board and so forth.

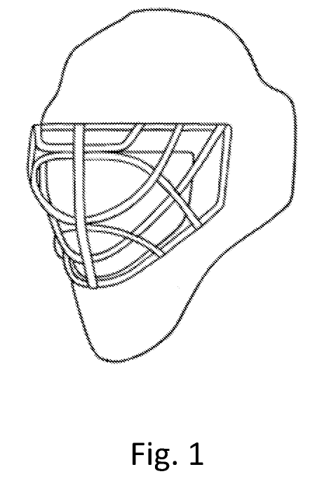

Attention now is directed towards embodiments of the helmet. FIG. 1 is a diagram illustrating a helmet in accordance with some embodiments. As shown by FIG. 1, the helmet of the present invention looks similar to any of conventional helmets when looking at it from outside. In one embodiment, the helmet has a hard cover for most part of a head and a net mask for facial part, and there are soft cushion parts under the hard cover such as foam paddings, so the helmet can protect the head from injury caused by mechanical strikes.

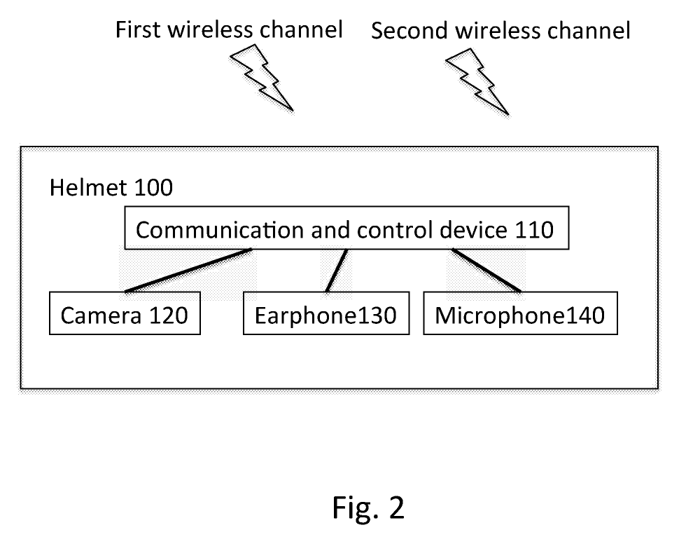

FIG. 2 is a block diagram illustrating different parts in the helmet in accordance with some embodiments. According to FIG. 2, helmet 100 comprises a camera 120, an earphone 130, a microphone 140 and a communication and control device 110. And communication and control device is connected with camera 120, earphone 130 and microphone 140, and the connection can be made via regular wire. Communication and control device 110 receives video signals from camera 120 and transmits the video signal out via a first wireless channel, receives a first audio signal from microphone 140 and transmits the first audio signal out via a second wireless channel, and receives a second audio signal via the second wireless channel and transmit the second audio signal to earphone 130.

In one embodiment of the invention, earphone 130 is embedded at an inner helmet part, which is corresponding to position of helmet wearer's ear. And earphone 130 can be embedded into inner padding part of helmet 100, or can be installed in a hole on inner padding part of helmet 100. Although not illustrated explicitly in the drawings, it should be understood that earphone 130 can be a single device installed at one inner side of helmet 100, or a pair of devices installed at both inner side of helmet 100 respectively.

In one embodiment of the invention, microphone 140 is embedded or installed at the inner helmet part which is close to position of helmet wearer's mouth, such that helmet wearer's voice can be easily picked up.

In one embodiment of the invention, camera 120 is embedded or installed on the helmet outer cover, for example, at the forehead part of the helmet outer cover. Camera 120 is arranged or installed so that no part of camera 120 protrudes or extend outside of outer cover helmet 100, then when something strikes on the part of outer cover of helmet 100 where camera 120 is installed, camera 120 won't be damaged.

In one embodiment of the invention, communication and control device 110 is embedded or installed at inner part of helmet 100, for example, communication and control device 110 can be installed into inner padding cushion of helmet 100 such that it can be protected from mechanical damage due to strikes. Earphone 130, microphone 140 and camera 120 are all connected to communication and control device 110 via wire connections. It should be understood that communication and control device 110 has at lease a processor with programs to carry on all necessary functions of the invention, and a communication means which can make wireless communications using many wireless communication methods including but not limited to WiFi, bluetooth, cellular network, zigbee, and cordless phone channel. Particularly, communication and control device 110 can use any of wireless communication method to communicate with other counterparts through the communication means.

It should be understood that when talking about different wireless channels in present invention, in most of time, it means different wireless communication methods including but not limited to WiFi, bluetooth, cellular network, zigbee, and cordless phone channel. Therefore, in one embodiment of the invention, the first wireless channel is one of WiFi, bluetooth, cellular network, zigbee, cordless phone channel, and the second wireless channel is the other one of WiFi, bluetooth, cellular network, zigbee, cordless phone channel.

For example, communication and control device 110 receives video signals from camera 120 and transmits the video signal out via a first wireless channel such as WIFI, receives a first audio signal from microphone 140 and transmits the first audio signal out via a second wireless channel such as bluetooth, and receives a second audio signal via the second wireless channel such as bluetooth and transmit the second audio signal to earphone 130.

In another example, communication and control device 110 receives video signals from camera 120 and transmits the video signal out via a first wireless channel such as cellular network, receives a first audio signal from microphone 140 and transmits the first audio signal out via a second wireless channel such as cordless phone channel, and receives a second audio signal via the second wireless channel such as cordless phone channel and transmit the second audio signal to earphone 130.

In one embodiment of the invention, the first wireless channel and the second wireless channel is a same wireless channel. That is, communication and control device 110 uses one wireless channel to transmit the video signal out of helmet 100 and to transmit audio signal out of helmet 100 and receive audio signal from outside of helmet 100.

In one embodiment of the invention, the same wireless channel is any one of WiFi, bluetooth, cellular network, zigbee, cordless phone channel. For example, communication and control device 110 uses WIFI to transmit the video signal out of helmet 100 and to transmit audio signal out of helmet 100 and receive audio signal from outside of helmet 100. In another example, communication and control device 110 uses cellular network to transmit the video signal out of helmet 100 and to transmit audio signal out of helmet 100 and receive audio signal from outside of helmet 100.

In one embodiment of the invention, communication and control device 100 receives and transmits a first audio signal and a second audio signal in a way to enable full duplex audio communication. In an example, a first audio signal is the audio signal from microphone 140 and a second audio signal is the audio signal received wirelessly by communication and control device 110. In an example, communication and control device 110 uses Voice over IP technology and WIFI to make communication with a terminal, such as a mobile phone, for the audio signals, such that wearer of helmet 100 and the terminal user can talk in a duplex way. In another example, communication and control device 110 can use cordless phone channel or

Bluetooth to make duplex audio communication wireless for a helmet wearer and a terminal user.

In an example of the invention, a first audio signal is generated by microphone 140 after collecting voice of wearer of helmet 100, then microphone 140 transmits the first audio signal to communication and control device 110, next, communication and control device 110 transmits the first audio signal via a wireless channel to a terminal such as a mobile phone, then the terminal generates sound at its speaker according to the first audio signal, such that the terminal user can hear the voice of wearer of helmet 100. At the same time, the terminal generates a second audio signal according to voice received by its microphone, then the terminal transmits the second audio signal via a wireless channel to communication and control device 110 of helmet 100, then communication and control device 110 transmits the second audio signal to earphone 130, next, earphone 130 generates sound according to the second audio signal, such that wearer of helmet 100 can hear the voice of the terminal user. Therefore, wearer of helmet 100 and the terminal user can talk to and hear each other at the same time, that is, duplex audio communication.

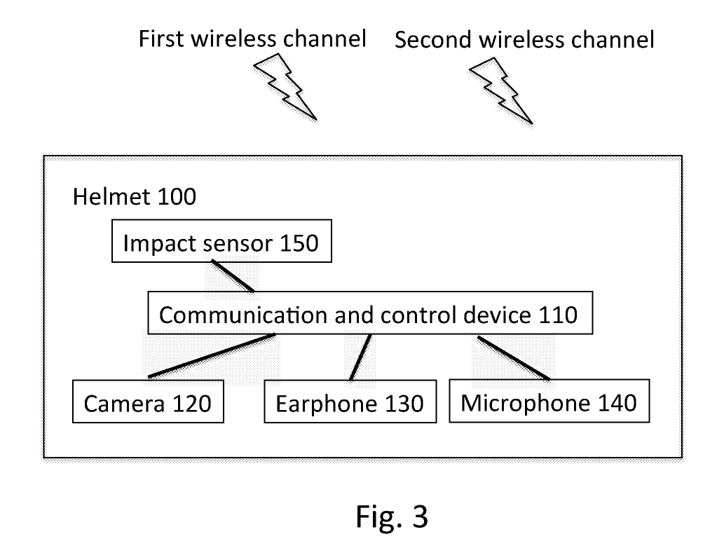

FIG. 3 is a block diagram illustrating different parts in the helmet in accordance with some embodiments. As shown in FIG. 3, in one embodiment of the invention, helmet 100 further comprises impact sensor 150 configured to detect mechanical impact force received by helmet 100 and connected to communication and control device 110.

In an example, impact sensor 150 is installed just under outer cover of helmet 100, such that impact sensor 150 can do sensing properly. When helmet 100 is hit or struck mechanically, the mechanical impact force can be detected by impact sensor 150.

In one embodiment of the invention, communication and control device 110 receives the impact detection result from impact sensor 150 then transmits out the impact detection result via any one of a first wireless channel and a second wireless channel.

In an example, after impact detection result is generated, impact sensor 150 sends it to communication and control device 110. At communication and control device 100, it continuously receives impact detection result from impact sensor 150, then communication and control device 100 can continuously send out the impact detection result via any one of the first or second wireless channel. And, at other end of the wireless channel, a terminal, such as a mobile phone, continuously receives the impact detection result. The terminal can continuously display the impact detection result on its screen. Alternatively, the terminal can continuously display the impact detection result on its screen together with video obtained from the video signal received from helmet 100. Alternatively, communication and control device 110 can continuously embed the impact detection result into video signal which it is going to sends out wirelessly, for example by overlying then impact detection result as a number shown on video image, then when a terminal receiving the video signal displays video derived from the video signal, the impact detection result is automatically shown on the video screen.

Alternatively, communication and control device 110 may not send out the impact detection result continuously, in contrast, communication and control device 110 sends out the impact detection result through wireless channel only if it is determined that the impact detection result reaches a threshold which can be set as needed. Therefore, once a terminal, such as a mobile phone, receives then impact detection result through wireless channel it can inform related personal to take necessary action for the wearer of helmet 100.

In one embodiment of the invention, communication and control device 110 instructs earphone 130 to send out audio alarm if the impact detection result reaches a threshold In an example, when communication and control device 110 determines the impact detection result received from impact sensor 150 reach a threshold, it can instruct earphone 130 to send out an audio alarm which can be heard by the wearer of helmet 100 to inform the wearer he or she just get a serious hit on head. This audio alarm can be a mere sound, noise or beeping as those used by a regular clock alarm, or, alternatively, this audio alarm can be a number reading such as “100 pounds” or the like. Alternatively, this audio alarm can be a mere sound followed by a number reading.

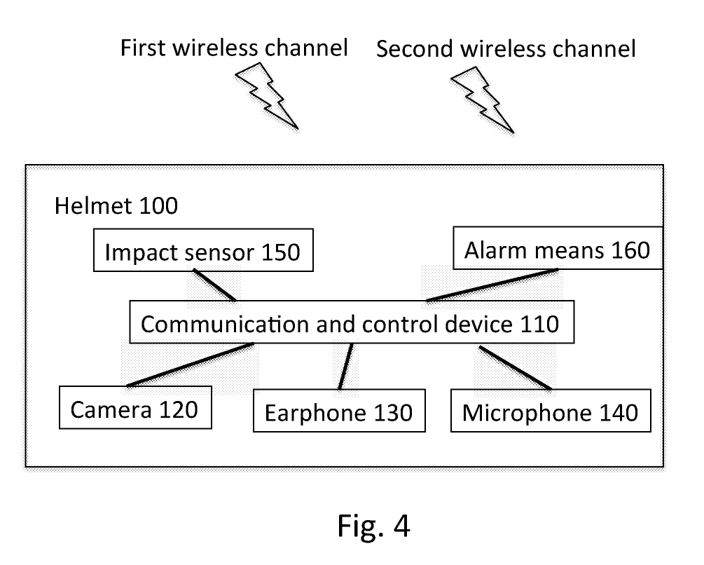

FIG. 4 is a block diagram illustrating different parts in the helmet in accordance with some embodiments. As shown in FIG. 4, in one embodiment of the invention, helmet 100 further comprises alarm means 160 connected with communication and control device 110, and communication and control device 110 can instruct alarm means 160 to send out alarm by visible light signal if the impact detection result reaches a threshold.

In an example, alarm means 160 is a light source, such as a LED, installed on outer cover of helmet 100, and alarm mean 160 can emit visible light continuously or in a flashing fashion when activated or turned on, such that its light emitting or flashing can be recognized by bare eye in a distance such as 50 meters/150 feet or more.

In an example, communication and control device 110 receives the impact detection result from impact sensor 150 then determine whether it reaches a threshold, and alarm means 160 is activated or turned on if the threshold is reached. Wearer of helmet 100 or other appropriate personal can set the threshold in advance.

In one embodiment of the invention, impact senor 150 comprises one or more of accelerometer, piezo electric sensor and microelectromechanical system (MEMS). In an example, the accelerometer is a 6-axis accelerometer. It should be understood, communication and control device 110 can make good calculation about how much mechanical impact force received by helmet 100 according to acceleration reading provided by the accelerometer.

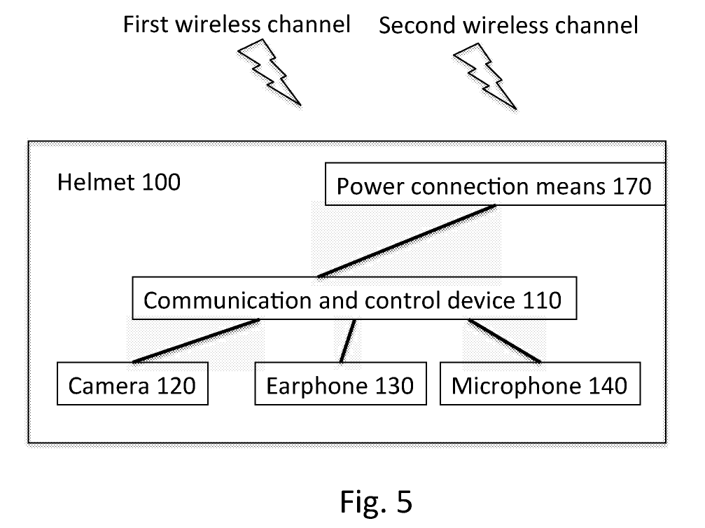

FIG. 5 is a block diagram illustrating different parts in the helmet in accordance with some embodiments. As shown in FIG. 5, in one embodiment of the invention, helmet 100 comprises a power connection means 170. A power source separated from helmet 100 can be connected to communication and control device 110 via power connection means 170.

In an example of the invention, a power source such as a battery is equipped in helmet 100 to supply power to communication and control device 110, then communication and control device 110 can supply power to other electronic components in helmet 100, such as camera 120, microphone 140, and earphone 130. In another example, no power source is equipped in helmet 100, then power connection means 170, such as a power line with a connector (USB connector for example), is provided at helmet 100, such that a separate power source can be connected to communication and control device 110 to supply power via power connection means 170.

In an example of the invention, a battery pack can be connected to power connection means 170 using USB connector, then the batter pack can be carried by wearer of helmet 100 at other part of his/her body, such as in his backpack or in bag hanging at his/her belt.

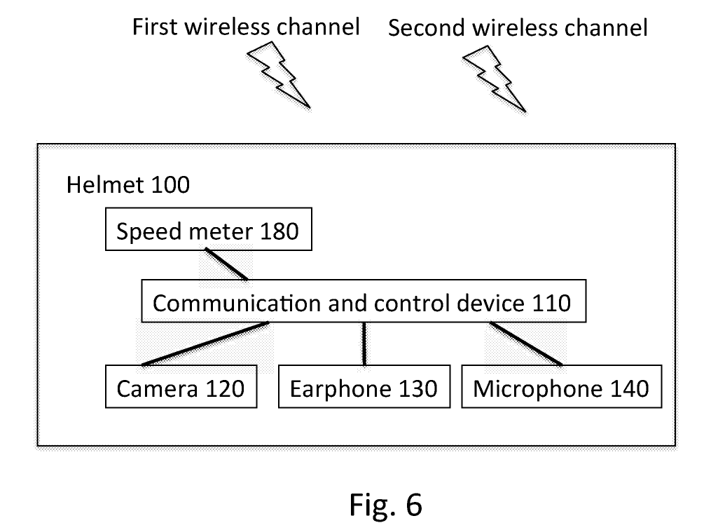

FIG. 6 is a block diagram illustrating different parts in the helmet in accordance with some embodiments. As shown in FIG. 6, in one embodiment of the invention, helmet 100 comprises speed meter 180. Speed meter 180 measures speed of the helmet 100 and send the speed measurement result to communication and control device 110. Communication and control device 110 transmits out the speed measurement result via any one of the first wireless channel and the second wireless channel.

In an example, after the speed measurement result is generated, speed meter 180 sends it to communication and control device 110. At communication and control device 100, it continuously receives the speed measurement result from speed meter 180, then communication and control device 100 can continuously send out the speed measurement result via any one of

the first or second wireless channel. And, at other end of the wireless channel, a terminal, such as a mobile phone, continuously receives the speed measurement result. The terminal can continuously display then speed measurement result on its screen. Alternatively, the terminal can continuously display the speed measurement result on its screen together with video obtained from the video signal received from communication and control device 110 of helmet 100. Alternatively, communication and control device 110 can continuously embed the speed measurement result into video signal which it is going to sends out wirelessly, for example by overlying then speed measurement result as a number shown on video image, then when a terminal receiving the video signal displays video derived from the video signal, the speed measurement result is automatically shown on the video screen.

Alternatively, communication and control device 110 may not send out then speed measurement result continuously, in contrast, communication and control device 110 sends out speed measurement result through wireless channel only if it is determined that the speed measurement result reaches a threshold which can be set as needed. Therefore, once a terminal, such as a mobile phone, receives the speed measurement result through wireless channel it can inform related personal to take necessary actions.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

We claim:

1. A helmet comprising:
a camera;
an earphone;
a microphone; and
a communication and control device connected with the camera, the earphone and the microphone;
wherein the communication and control device receives video signals from the camera and transmits the video signal out via a first wireless channel, receives a first audio signal from the microphone and transmits the first audio signal out via a second wireless channel, and receives a second audio signal via the second wireless channel and transmit the second audio signal to the earphone.

2. The helmet of claim 1, wherein the first wireless channel and the second wireless channel is a same wireless channel.

3. The helmet of claim 2, wherein the same wireless channel is any one of WiFi, bluetooth, cellular network, zigbee, cordless phone channel.

4. The helmet of claim 1, wherein the first wireless channel is one of WiFi, bluetooth, cellular network, zigbee, cordless phone channel, and the second wireless channel is the other one of WiFi, bluetooth, cellular network, zigbee, cordless phone channel.

5. The helmet of claim 1 or 2, wherein the communication and control device receives and transmits the first audio signal and the second audio signal in a way to enable full duplex audio communication

6. The helmet of claim 1, further comprising: an impact sensor configured to detect mechanical impact force received by the helmet and connected to the communication and control device.

7. The helmet of claim 6, wherein the communication and control device receives impact detection result from the impact sensor then transmits out the impact detection result via any one of the first wireless channel and the second wireless channel.

8. The helmet of claim 6, wherein the communication and control device receives the impact detection result from the impact sensor, and the communication and control device instructs the earphone to send out audio alarm if the impact detection result reaches a threshold.

9. The helmet of claim 6, further comprising: an alarm means connected with the communication and control device, wherein the communication and control device instructs the alarm means to send out alarm by visible light signal if the impact detection result reaches a threshold.

10. The helmet of claim 6, wherein the impact senor comprises one or more of accelerometer, piezo electric sensor and microelectromechanical system.

11. The helmet of claim 1, further comprising: a power connection means via which a power source separated from the helmet can be connected to the communication and control device.

12. The helmet of claim 1, further comprising:
a speed meter configured to measure speed of the helmet and send the speed measurement result to the communication and control device;
wherein the communication and control device transmits out the speed measurement result via any one of the first wireless channel and the second wireless channel.
